(19) United States
(12) Patent Application Publication
(10) Pub. No.: US 2014/0114882 A1
(43) Pub. Date: Apr. 24, 2014

(54) SYSTEM AND METHOD FOR ADVANCED RETIREMENT PLANNING

(71) Applicant: Edward D. Jones & Co., L.P., St. Louis, MO (US)

(72) Inventor: Scott A. Thoma, St. Charles, MO (US)

(73) Assignee: Edward D. Jones & Co., L.P., St. Louis, MO (US)

(21) Appl. No.: 14/058,535

(22) Filed: Oct. 21, 2013

Related U.S. Application Data
(60) Provisional application No. 61/716,161, filed on Oct. 19, 2012.

(51) Int. Cl. G06Q 40/00

(52) U.S. Cl. CPC G06Q 40/06
USPC 705/36 R

(57) ABSTRACT

A system and method to assist financial advisors in running different scenarios to help the client determine when and how to take their Social Security benefits, integrating the potential complexities of spousal and survivorship considerations and strategies, as well as overarching retirement income considerations, into the decision making framework.

This application claims the priority of U.S. Provisional Patent Application 61/716,161 filed Oct. 19, 2012.

The present disclosure is directed to an advanced retirement planning tool. Specifically, the tool can be used to assist financial advisors in running different scenarios to help the client determine when and how to take their Social Security benefits, integrating the potential complexities of spousal and survivorship considerations and strategies, as well as overarching retirement income considerations, into the decision making framework.

In the prior art, a typical Social Security planning tool was a standalone system which sought to maximize the payout of Social Security payments based on specific circumstances. For example, prior art tools may only use the information provided by annual Social Security statements provided by the U.S. government to develop predetermined scenarios to try to determine the most beneficial options for contributors. The annual Social Security statement issued by the Social Security Administration typically includes:
Year of birth;
Full Retirement Age (“FRA”), which is the age that a contributor is eligible to receive full Social Security benefits;
Monthly Social Security benefits if contributor begins to receive benefits at age 62;
Monthly Social Security benefits if contributor begins to receive benefits at FRA;
Monthly Social Security benefits if contributor begins to receive benefits at age 70.

FRA ranges from 65 to 67 depending on the contributor's year of birth. When a contributor reaches their FRA, they are entitled to their full monthly amount. A contributor's full monthly amount is based on the salary previously earned by the contributor in the years that they contributed to their Social Security account.

Social Security retirement benefits can be claimed as early as age 62, although the benefit will be reduced depending on the difference between the age when the contributor first claims benefits and the contributor's FRA. The Social Security Administration also offers enhanced monthly payments to contributors who postpone claiming their benefits beyond FRA. For every year beyond FRA that monthly payments are put off, the Social Security Administration provides a guaranteed annual increase of 7 to 8 percent to the contributor's full monthly amount.

A contributor may also be eligible for spousal and survivor benefits. For a married couple (as well as potentially for divorced individuals), the Social Security Administration designates a primary earner and a secondary earner. The primary earner is the spouse having the higher salary used to compute the full monthly amount. The secondary earner is the spouse having the lower salary used to compute the full monthly amount. The secondary earner is entitled to spousal benefits equal to 50 percent of the primary earner's full monthly amount provided the primary earner is eligible and has filed for benefits, without regard to whether the primary earner is actually receiving payments. In addition, the secondary earner may also be entitled to his/her own benefit.

The Social Security Administration also permits survivor benefits. In the event that the primary earner dies first, the secondary earner may be entitled to survivor benefits. Survivor benefits will be at least equal to the primary earner's actual benefit at the time of death. If the primary earner dies before filing for benefits, the Social Security Administration will calculate the primary insurance amount for the decedent using the previous years' earnings as of the year of death. A surviving spouse can collect a survivor benefit as young as age 60, subject to a reduction. The decision by the primary earner concerning when to collect his or her individual Social Security benefits, whether it be at age 62, at FRA, at age 70, or somewhere in between these ages, has a direct impact on any survivor benefit that may be paid to the surviving spouse.

Prior art retirement tools had limited ability to account for the various scenarios that need to be considered and provide a comprehensive analysis of options. For example, some tools are limited to the scenarios presented in the annual Social Security statement, i.e., benefits at age 62, 70 and FRA. Other tools are limited to basic spousal considerations, and thus only be able to portray the output for a married couple, which may not be flexible enough to consider divorced spousal/survivor benefits and/or advanced spousal claiming strategies. Another tool might allow minimal customization by running predetermined scenarios with different life expectancies. Another tool might focus on preconfigured scenarios (claim at age 62, claim at age 70) and show the user results, but not have the flexibility to allow the individual(s) the flexibility to change these preconfigured scenarios for other claiming ages in addition to the ones the tool suggests. Another tool might instead focus only on optimizing (or maximizing) benefits received, without focus on other important considerations, such as the effect on other assets. These prior art tools did not have the capacity to integrate all of the above items—to not only determine the most advantageous scenario for claiming Social Security benefits jointly for the individual and spouse, including the numerous considerations such as outside earnings, differing ages of the spouses, divorce and/or survivor benefits—as well as give the individual the flexibility to dynamically run scenario analysis (i.e. to look all potential claiming ages as well as spousal strategies), but more importantly to be able to illustrate the effect the Social Security claiming decision might have on their overall retirement income strategy (e.g. analyzing the effect of different claiming strategies on required withdrawals from investments to provide for overall retirement income needs).

Prior art tools typically isolated the Social Security decision (as well as potentially limited the scope of the analysis, such as only for non-working married couples), and did not analyze how that decision might affect the client's overarching retirement income strategy (i.e. is there a material impact to the investment portfolio if an individual must spend down retirement assets while he/she is delaying to claim Social Security, or does delaying Social Security help improve the overall probability their retirement income strategy is successful). Moreover, the tools were static and did not have the ability to dynamically adapt to multiple inputs and highlight to the individual in real time when spousal strategies are available and should be considered.

The present disclosure provides a comprehensive evaluation of potential options for claiming Social Security benefits which addresses the shortfalls of the prior art tools described above. In one embodiment, the present disclosure provides an analysis of lifetime income potential of the analyzed retirement scenarios, and the effect on the survivor's income (if applicable), utilizing a novel life expectancy, employment, need and spouse using applicant's proprietary LENS decision framework in the output. This LENS decision framework can help the individual determine when to claim Social Security by focusing on the key elements of the decision, including:
L—Life Expectancy—which focuses on lifetime benefits received as well as breakeven analysis between different claiming options
E—Employment—which focuses on the potential effect, if any, of the individuals employment earnings on benefits received
N—Need—which focuses on the individual's overarching retirement income needs and the effect the claiming decision may have on the individual's ability to reach the retirement income goal
S—Spousal Considerations—which focuses on the effect of the claiming decision on the spouse, including potential spousal, survivor, and divorced spousal considerations and strategies

In another embodiment, the present disclosure can be used to provide a comprehensive Social Security claiming decision analysis on a standalone basis. In another embodiment, the tool could incorporate the results of the aforementioned Social Security claiming analysis into a more comprehensive retirement income analysis. By analyzing the client's overarching retirement income goals, the financial advisor can analyze the following in light of their selected Social Security claiming strategy, including;
Ability to achieve overarching retirement income goals
Sustainability of client's retirement investment portfolio
Potential effect on remaining assets targeted for estate purposes

### BRIEF DESCRIPTION OF THE DRAWINGS

FIG. 1 is a simplified architecture of one embodiment of the current disclosure.

FIG. 2 is an example of a user input screen for one embodiment of the present disclosure.

FIG. 3 is an example of an analysis of potential Social Security benefits for two options for one embodiment of the present disclosure.

FIG. 4 is an example of an analysis of potential Social Security benefits for two options using a LENS analysis summary for one embodiment of the present disclosure.

FIG. 5A is an example of an analysis of potential Social Security benefits for two options showing a monthly benefits comparison for one embodiment of the present disclosure.

FIG. 5B is an example of an analysis of potential Social Security benefits for two options showing a breakeven analysis for one embodiment of the present disclosure.

FIG. 5C is an example of an analysis of potential Social Security benefits for two options showing a survivor benefit analysis for one embodiment of the present disclosure.

FIG. 6 is an example of an analysis of potential Social Security benefits for two options showing a yearly benefits comparison for one embodiment of the present disclosure.

### DETAILED DESCRIPTION OF THE DRAWINGS

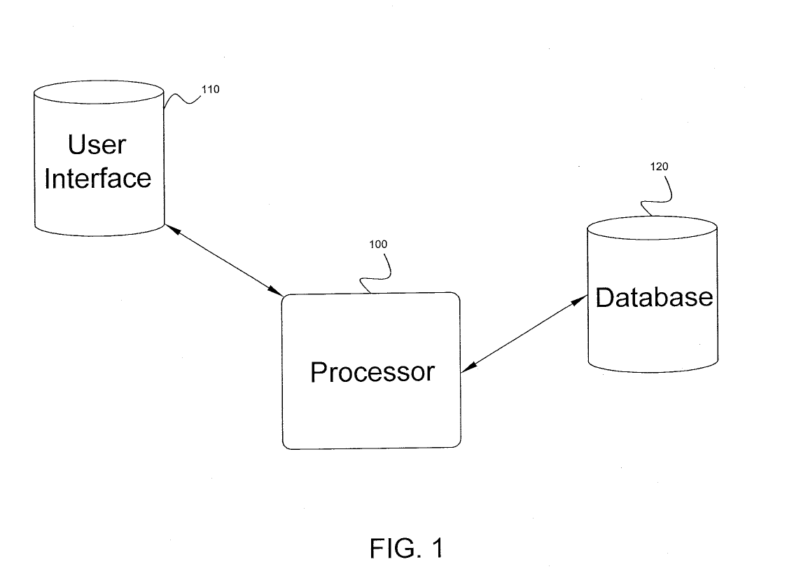

With reference to FIG. 1, the present disclosure can be implemented using a processor 100 in communication with database 120. A financial advisor and/or end user can use user interface 110 in communication with processor 120 to provide information and respond to queries from the processor, and can be used to display evaluations provided by processor 120. The processor can be programmed to conduct Social Security claiming decision analyses and evaluate available scenarios to allow end user to fully appreciate how the various scenarios may impact the retirement income strategy of the end user.

Database 120 may contain all the current rules and regulations of the Social Security Administration in order to identify available options. Database 120 may also contain account information for an end user. The account information may include bank account, investment account, or other types of accounts associated with the end user, investment and retirement goals, income and spending information, and any other information that may be relevant to retirement planning for the end user. User interface 110 may also be used to provide information for storage in the database 120, or to provide information to the processor to be used for retirement planning, as is discussed in more detail below.

In one embodiment, processor may have software to perform comprehensive investment and retirement planning for an end user, and database 120 may include all information necessary to performance comprehensive investment and retirement planning. One such comprehensive investment and retirement planning system is described in commonly owned U.S. patent application Ser. No. 13/724,691 titled “System and Method for Income Managed Account”, the disclosure of which is hereby incorporated by reference herein. In another embodiment, a separate processor and database may be used for the comprehensive investment and retirement planning communicating with processor 100, user interface 110 and database 120.

The present disclosure has the ability to estimate monthly benefit amounts, as well as cumulative benefits received, making adjustments for:
Age of Claiming (Increase in benefits if delayed, reductions in benefits if taken early)
Spousal Benefit eligibility (and adjustments if taken early)
Spousal Claiming Strategies (i.e. File & Suspend, Restricted Application, also referred to as Claim Spousal Benefit Now, Claim Your Own Benefit Later)
Cost-of-Living Adjustments
Divorced Spouse Benefits
Earned Income Adjustments (if Social Security is claimed prior to FRA—i.e. the Earnings Test) If an individual works while receiving Social Security benefits, the earnings will reduce the monthly benefit amount until FRA.
Survivor benefits for spouse, divorced spouses and children
Windfall Elimination Provision/Government Pension Offset (WEP/GPO). If an individual works for an employer who does not withhold Social Security taxes, such as a government agency or an employer in another country, any pension based on that work may reduce the individual's Social Security benefits. The Windfall Elimination Provision affects how the amount of retirement or disability benefits are calculated if the individual receives a pension from work where Social Security taxes were not taken out of the salary. A modified formula is used to calculate the benefit, resulting in a lower Social Security benefit than would otherwise be received.

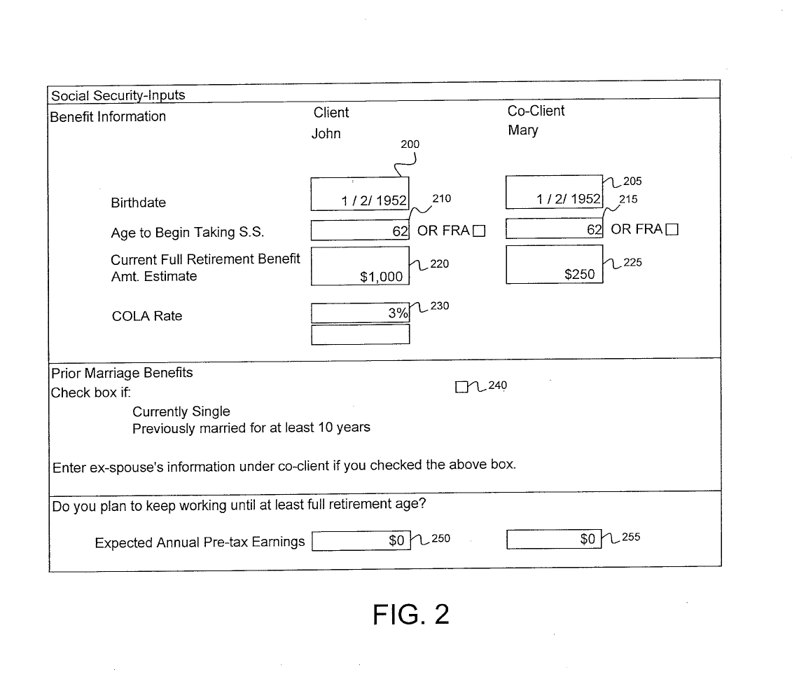

In operation, user interface 110 may provide a screen shot of one embodiment illustrated in FIG. 2 showing the inputs for the planning tool. This interface may be utilized by an individual, or the individual's financial advisor. This initial input screen can be populated with information provided by the individual, including information from the individual's annual Social Security Administration report discussed previously. If the user interface is utilized by a financial advisor, the individual may be referred to as a “Client.” The client's information of birthdate 200, age to begin receiving Social Security benefits or client's FRA 210, current full retirement monthly benefit 220, and cost of living adjustment rate 230 can be used to predict the monthly benefit that the client would be projected to receive during his/her lifetime. If the client is married, the spouse could be identified as a “co-client” and the financial advisor could input the birthdate 205, age to begin receiving Social Security benefits or spouse's FRA 215, current full retirement monthly benefit 225 information for the spouse. If “Prior Marriage Benefits” section 240 is checked, the “Co-Client” line may change to “Ex-Spouse,” and the financial advisor could input the relevant information for the ex-spouse. The financial advisor may also use user interface 110 to input information regarding dependents of the client or co-client for the purpose of evaluating survivor benefits.

If the client, or co-client, intends to keep working until FRA, the financial advisor can indicate the expected annual pre-tax earnings 250, 255, as this may have an impact on the monthly benefit amount. In another embodiment, if an individual works for an employer who does not withhold Social Security taxes, this can be input in order to take into account WEP/GPO discussed above.

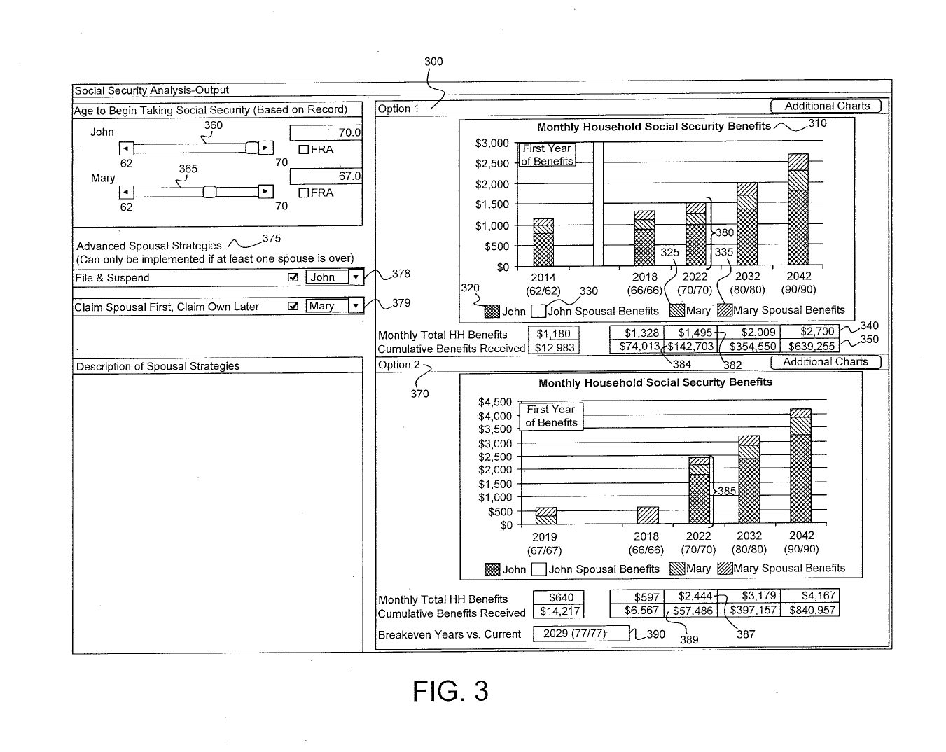

With reference to FIG. 3, in one embodiment, based on the client's initial inputs, a graphical display is presented to show potential retirement options. “Option 1” 300 could show monthly benefit estimates 310 for client and spouse (if married)—categorizing the benefit payment into its component parts of retirement benefit for the client 320 and the spouse 325 and/or spousal benefit, if any 330, 335—based on their initial plans on claiming Social Security. The graphical display presents monthly total household benefits 340, as well as cumulative benefits received from Social Security over time 350.

One problem with prior art planning tools is that the presentation of the data can be complex and confusing and thus the effects of various retirement decisions can not be plainly presented. For example, some prior art planning tools present the data only numerically using a table or a chart, thus making it difficult to identify trends or identify break-even or cross-over points. In one embodiment, the present disclosure obviates this deficiency by proving a graphical display of the results of the retirement decisions made by a Social Security recipient. The present disclosure allows the financial advisor to use slider bars 360, 365 to change the ages that both spouses (if married) intend to take Social Security, and the tool would dynamically calculate their monthly and cumulative benefit amount. If two options are considered, the tool would also show a “breakeven” year comparing the options, helping users to visualize the results of their retirement decisions in order to optimize their benefit amount from Social Security. For example, if the individual(s) delayed Social Security to receive a higher monthly benefit, the tool would highlight the year (and corresponding age(s) for the individual(s)) that the higher cumulative benefit received for delaying would become larger than the cumulative benefits received from claiming a smaller benefit earlier. The tool could also highlight the potential survivor benefits received based upon the projected date of death of either spouse to show the potential effects of the initial claiming decision on survivor benefits (and total monthly income). Similarly, the tool would show the effect, if any, of employment income on the Social Security benefit received—on retirement, spousal and survivor benefits—particularly if benefits are claimed prior to FRA. Additionally, the tool could be used for divorced individuals, highlighting potential divorced spousal and survivor benefits (along with all the above functionality regarding earnings, breakeven, etc.).

Generally, spousal benefits can only be received if the other spouse has also filed for and is receiving benefits. In another embodiment, the present disclosure can be used to analyze and visually present advanced spousal strategies such as “File & Suspend” and “Restricted Application” (also referred to as “Claim Your Spousal Benefit Now, Claim Your Own Benefit Later”). The user interface graphical display could proactively identify which strategies are available, and which spouse could employ these strategies. The advanced spousal claiming strategies could be utilized if certain conditions are met to maximize household benefits received. For example, for “File & Suspend” assuming a client has not filed for benefits before FRA, at FRA, the client can file for benefits and then immediately suspend them. This strategy allows the “suspended” benefits of the client to grow and continue to earn delayed benefits credits. This strategy also permits the client's spouse to begin receiving spousal benefits. Another advanced spousal strategy is “Claim Spousal First, Claim Own Later”. Using this strategy, at FRA, an individual has the choice as to for his/her own benefits, or, if the spouse has already filed for benefits, receive a spousal benefit and delay filing for their own benefits. This strategy allows the individual to begin receiving spousal benefits at FRA, but also allow the individual's own benefit to grow and receive delayed benefits at a later date.

These advanced strategies introduce a complexity that was difficult to clearly illustrate using prior art retirement tools. The present disclosure provides a comprehensive view of available options with the ability to provide graphical displays providing instantaneously effects of the advanced strategies.

With continuing reference to FIG. 3, Option 1 300 illustrated the expected monthly and cumulative benefits based on the inputs from the input screen of FIG. 2. In Option 1 both John and Mary selected to begin receiving their own benefits 320, 325 at age 62. In addition, Mary is entitled to receive a spousal benefit 335.

In Option 2 370, the graphical display shows the results from the information selected by the slider bars 360, 365 and the advanced spousal strategies 375. The slider bars at the top would allow financial advisor to dynamically change the age of claiming for both John 360 and Mary 365 and view the effects on Option 2 in real-time. In this Option 2, John has selected to “File & Suspend” 378 and delay receiving his benefits until age 70. Mary has elected to “Claim Spousal First, Claim Own Later” 379 and will receive spousal benefits beginning at age 67 and will delay receiving her own benefit until age 70. The different colors in the bar charts represent the benefits from each spouse, including potential spousal benefits. A breakeven year is shown under Option 2 that shows when the cumulative benefits from Option 2 exceed Option 1.

FIG. 3 provides a simple graphical presentation of Option 1 and Option 2 to allow the users to see the practical effects of the retirement choices they made. For example, in the year 2012, Option 1 300 illustrates a color coded bar chart showing the benefits for John and Mary and the spousal benefits for Mary relative to each other. The monthly total household benefit 382 is $1495, and the cumulative benefits received 384 up to that point in time is $142,703. Option 2 370 illustrates a color coded bar chart showing the benefits for John and Mary and the spousal benefits for Mary, relative to each other. The monthly total household benefit 387 is $2,444, and the cumulative benefits received 389 up to that point in time is $57,486. Thus, FIG. 3 shows how the complexity of evaluating retirement decision options can be simplified for graphical presentation to the users to assist them in understanding the practical effect of their retirement decisions. In addition, a breakeven point 390 can be identified which indicates when the cumulative benefits of Option 1 and Option 2 are equal signifying that Option 1 may be more beneficial up to year 2029, and that Option 2 is more beneficial after year 2029.

Prior art tools did not have the flexibility of the present disclosure which allows any potential combination of claiming timetables between the ages of 62 and 70 for either the individual or for both individuals in the couple. Prior art tools were restricted to predefined scenarios limited to ages 62, 70 and FRA. Because the present disclosure is not limited to predefined scenarios, it can display a breakeven age between compared scenarios. For example, if the individual is deciding between claiming at age 63 versus age 68, the present disclosure would display the year and age that the cumulative benefits received between either claiming later (and receiving a higher benefit) versus claiming earlier and receiving a lower benefit (but for 5 additional years) would cross.

In addition to allowing the users and financial analyst to customize potential options using the slider bar, the present disclosure may also provide predefined scenarios that could be selected for the analysis. The predefined scenarios can be presented in a pull-down menu presented by the user interface and include “Optimize Results”; “Claim As Early As Possible”; “Claim As Late As Possible”; “Full Retirement Age.” An optimizer can run scenarios to determine the most optimal age combination that would either maximize monthly or cumulative benefit payments, which would then be displayed on the output screen. Likewise, the present disclosure can run scenarios for claiming as early as possible, or as late as possible, or at FRA, which may be useful to see how these strategies fit with other retirement planning strategies, i.e., the selection of bond maturity dates or other investment decisions.

The present disclosure could be used as a standalone analysis tool, or the results may be automatically input into financial planning systems, whereby the effect of the Social Security decision could be integrated into an analysis of the client's overarching retirement income and financial legacy strategies. For example, financial planning tools attempt to capture all income that is expected to be received and all expenses that are expected to be paid in order to make life planning decisions relating to continued employment, insurance products, investment products. Social Security benefits is typically an important input for financial planning purposes. The more accurate the prediction of social security benefits, the more accurate the information being provided by the financial planning tool. For example, a financial advisor using the present disclosure may be able to accurately predict the monthly benefit from Social Security, which could assist the financial advisor in selecting and managing investments to ensure that monthly retirement goals for the client are met. Likewise, if the client delayed taking Social Security to maximize benefits, but then increased withdrawals from investments to make up any income need during this period, the tool could analyze these effects and determine if these choices improved the client's likelihood of achieving his/her overall retirement income goals over time.

In one embodiment, the present disclosure can generate a client report with charts and graphics showing the following features:
Monthly benefit comparisons between the two options (incorporating a COLA, if applicable)
Breakeven analysis (on lifetime benefit income) (the “L” in the LENS framework)
Optimized claiming strategy (i.e. the age combination and spousal strategies that results in highest monthly or lifetime benefits based on expected life expectancy)
Effect of outside employment income on benefit levels (i.e. the Earnings Test) (the “E” in the LENS framework)Effect of Social Security on overall retirement income strategy
Effect of Social Security on overall retirement income strategy (the “N” in the LENS framework)
Spousal effects (spousal and survivor benefits, as well as the effect of the aforementioned spousal strategies—the “S” in the LENS framework)

Thus, the present disclosure calculates the estimated monthly benefits based on different claiming ages in addition to a lifetime “cumulative” benefit, and the results can be displayed in real-time dynamically by using the slider bars to adjust the age at which the individual claims benefits. In addition, the results can also be shown by year (i.e., 2014, 2015, etc.) in addition to the individual ages so that the results can be more easily analyzed. For example, the results can show monthly benefits in 2017, when the individual and spouse became 66 and 62 respectively, as well as cumulative benefit received, including any spousal benefits if applicable, form the time claimed until 2017, and every year after that until the end of the planning horizon.

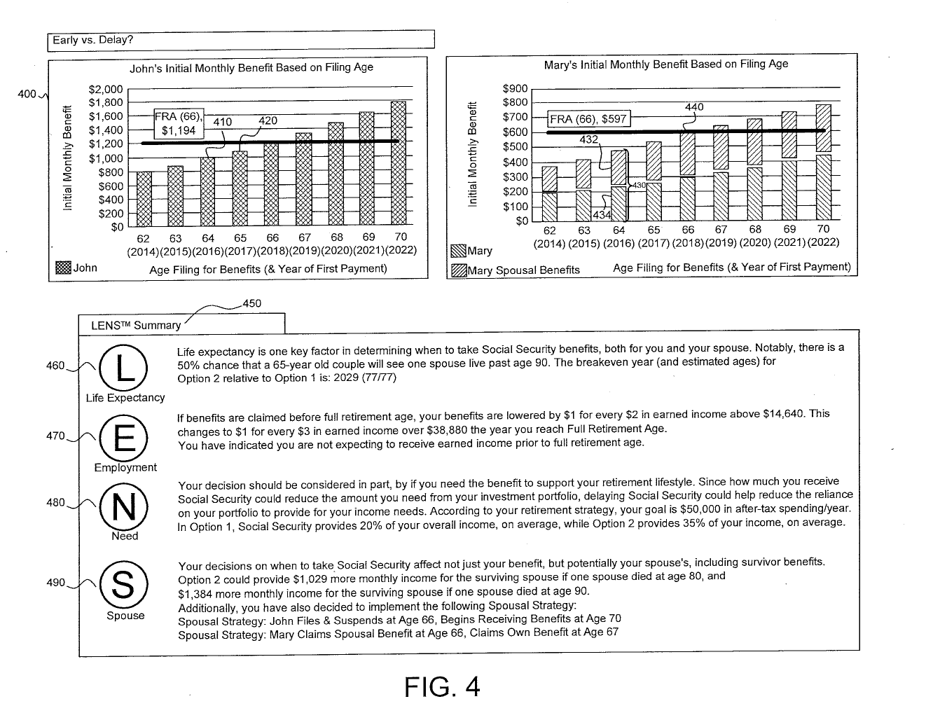

FIG. 4 illustrates an online interactive report provided by one embodiment of the present disclosure that provides a summary of potential monthly benefits based on the age first filed for benefits and a summary of the LENS analysis. The LENS analysis includes consideration of the following factors:
(L) Life Expectancy—focuses on the breakeven year and ages at breakeven point for two analyzed options
(E) Employment—focuses on any potential effect of the earnings test on the withholding of benefits for each of the two options as well as any potential effect of Windfall Elimination Provision (WEP) or Government Pension Offset (GPO)
(N) Need—focuses on the effect of the claiming decision on the overarching retirement strategy taking into account other income, investments, expenses and goals
(S) Spouse—focuses on any potential spousal/survivorship (and divorced spousal/survivor) considerations, including spousal claiming strategies.

The first part of the report shows a graphical analysis of the initial potential monthly benefit for each individual depending on the age the individual first files for benefits. For example, if John elected to receive benefits beginning at age 64, his initial monthly benefit 410 would be about $1000, compared to his initial monthly benefit 420 at FRA of about $1100. For Mary, if she elected to receive benefits beginning at age 64, her initial monthly benefit 430 would be about $475 (including her benefit 434 and her spousal benefit 432), compared to her initial monthly benefit 440 at FRA of about $600.

With continued reference to FIG. 4, a LENS analysis summary 450 is provided analyzing Options 1 and 2 from FIG. 3. The “life expectancy” 460 factor identifies that the breakeven year for Option 2 relative to Option 1 is 2029 when John and Mary are both 77. The “employment” factor 470 identifies John and Mary are not expected to receive earned income prior to FRA. The “needs” 480 factor indicates that John and Mary had indicated that their retirement goal is $50,000 in after-tax spending per year, and Option 1 provides Social Security benefits that provide 20% of the goal, while Option 2 provides benefits that meet 35% of that goal. This is an example of how the present disclosure can be integrated with other financial planning tools to help achieve overall financial planning goals.

The “spouse” factor 490 identifies that Option 2 could provide $1029 more monthly income for the surviving spouse if one spouse died at age 80, and $1384 more monthly income for the surviving spouse if one spouse died at age 90, based on the advanced spousal strategies selected. This is the type of information which could be provided to financial planning tools to take into account the increase in retirement benefits should one of the spouse die, which may impact investment strategies. In another embodiment, the LENS analysis summary could be run between one of the two analyzed options and an “Optimized” option. The optimized option could be an option that provides either the highest monthly or cumulative benefits.

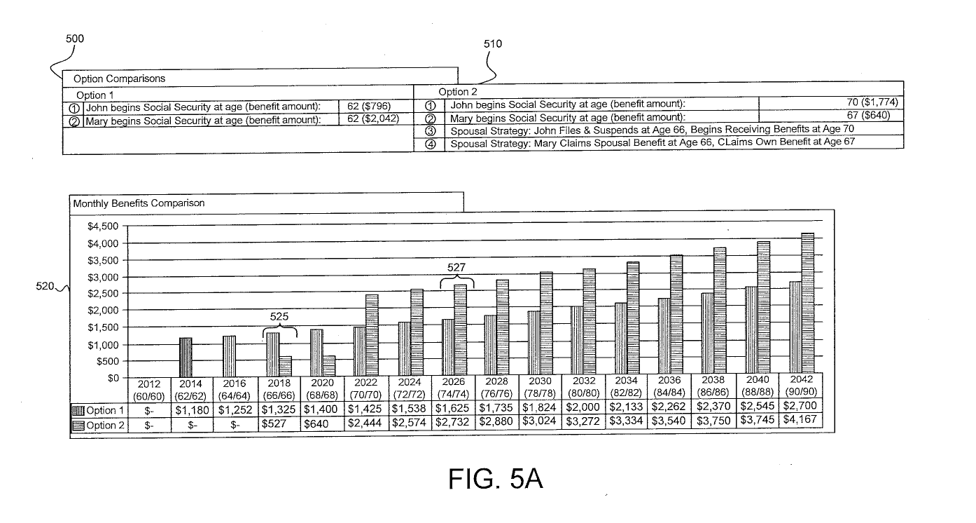

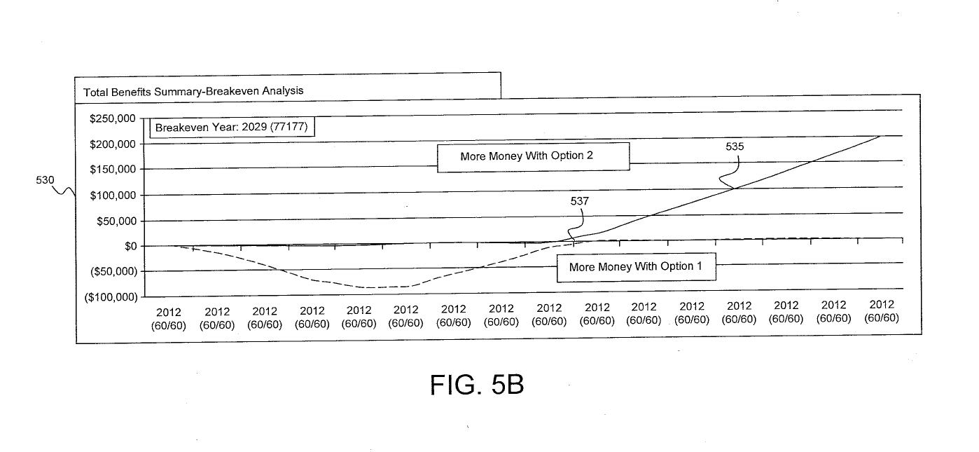

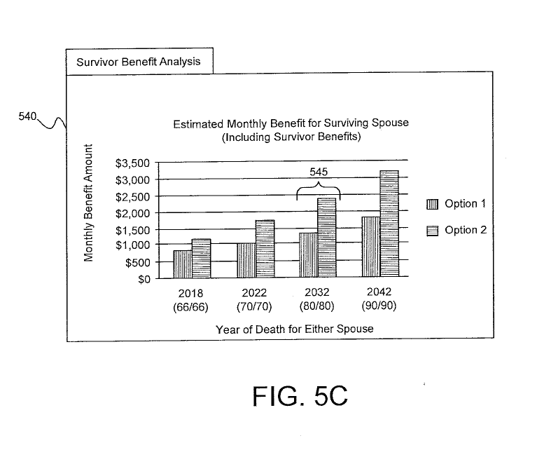

FIGS. 5A, 5B and 5C illustrate a reports from another embodiment that provide a breakdown in more detail of a comparison between Option 1 500 and Option 2 510, including a monthly benefits comparison 520, a breakeven analysis 530 and a survivor benefit analysis 540.

With reference to FIG. 5A, the monthly benefits comparison 520 graphically illustrates using a color coded bar graph the total monthly household benefit by year for Option 1 and Option 2. For example, in year 2018, total monthly household benefit 525 for Option 1 is more than twice the total monthly household benefit of Option 2. However in year 2028, the total monthly household benefit 527 is about $1100 less for Option 1 as compared to Option 2.

With reference to 5B, the breakeven analysis 530 provides a graph 535 that illustrates the difference in estimated cumulative total income between Option 1 and Option 2. For example, up until the breakeven point 537 occurring in 2029, Option 1 provides a greater cumulative benefit, and after 2029, Option 2 provides a greater cumulative benefit.

With reference to FIG. 5C. the survivor benefit analysis provides a graphical illustration of the estimated survivor benefits should one spouse die under both Options 1 and 2. For example, if one spouse dies in 2032, the surviving spouse's monthly benefit would be about $2500 for Option 2 as compared to about $1400 for Option 1. The survivor benefit analysis is but just one example of the ability of the present disclosure to provide detailed analyses by year comparing options for complex retirement scenarios and presenting the results in an easy to read graphical format, and is a feature that is lacking in prior art tools.

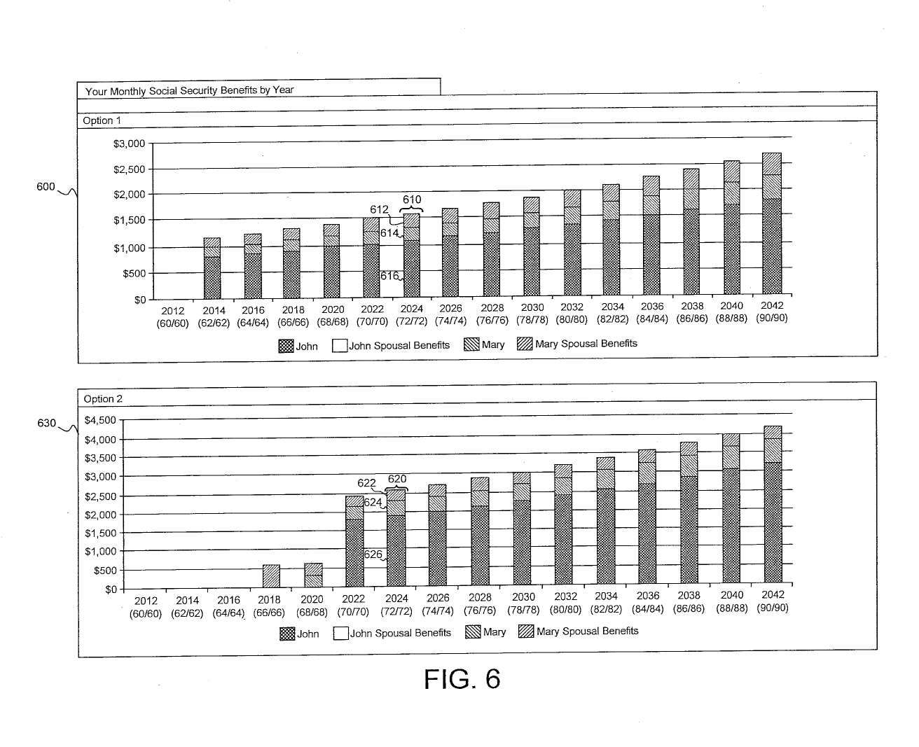

FIG. 6 illustrates a report produced by one embodiment of the present disclosure that provides a comparison between the monthly income detail 600, 610 for Options 1 and 2, highlighting the components of the monthly benefit, such as retirement, spousal, and survivor benefits. For example, in year 2024, the total monthly benefit 610 is about $1550 (including John's benefit 616, Mary's benefit 614 and Mary's spousal benefit 612) for Option 1 and the total monthly benefit 620 is about $2550 (including John's benefit 626, Mary's benefit 624 and Mary's spousal benefit 622) for Option 2.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable non-transitory medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed:

1. A method for advanced retirement planning, comprising the steps of
in a processor, receiving first input for a recipient of Social Security benefits, the first input including a current age of the recipient, and a monthly benefit at full retirement age for the recipient;
in a processor, receiving second input for a spouse of the recipient, the second input including a current age of the spouse, and a monthly Social Security benefit at full retirement age for the spouse;
accessing a database of information regarding Social Security information benefits information for the recipient and the recipient's spouse;
in a processor, receiving first data indicating the respective first ages at which the recipient and the spouse will begin receiving Social Security benefits;
providing a graphical display of a monthly benefit available to the recipient and the spouse based on the first data;
providing a graphical interface to receive second data indicating the respective second ages at which the recipient and the spouse will begin receiving Social Security benefits;
dynamically altering the provided graphical display to display a monthly benefit available to the recipient and the spouse based on the second data.

2. The method of claim 1 further including the step of simultaneously displaying monthly Social Security benefits available to the recipient and the spouse based on the first data and the second data.

3. The method of claim 2 further comprising the step of simultaneously displaying a graphical display of cumulative Social Security benefits for the recipient and the spouse for the first and second data including identifying a breakeven point.

4. The method of claim 3 further comprising the step of simultaneously displaying a graphical display of a monthly benefit for surviving spouse for the first and second data for a plurality of ages of death for a non-surviving spouse.

5. The method of claim 2 wherein the displayed monthly Social Security benefits include an indication of individual and spousal benefits for the recipient and the spouse.

6. The method of claim 1 wherein the second data indicates that the recipient desires to file and suspend the recipient's Social Security benefits.

7. The method of claim 1 wherein the second data indicates that the spouse desires to claim spousal benefits first and individual benefits later.

8. The method of claim 1 wherein the first and second inputs are received from a database.

9. The method of claim 1 wherein the graphical interface includes a slider bar to input the second data.

10. A system for advanced retirement planning comprising:
a memory for storing computer readable code;
a processor operatively coupled to the memory, the processor configured to:
receive first input for a recipient of Social Security benefits, the first input including a current age of the recipient, and a monthly benefit at full retirement age for the recipient;
receive second input for a spouse of the recipient, the second input including a current age of the spouse, and a monthly Social Security benefit at full retirement age for the spouse;
access a database of information regarding Social Security information benefits information for the recipient and the recipient's spouse;
receive first data indicating the respective first ages at which the recipient and the spouse will begin receiving Social Security benefits;
calculate a monthly benefit available to the recipient and the spouse based on the first data;
receive second data indicating the respective second ages at which the recipient and the spouse will begin receiving Social Security benefits;
calculate a monthly benefit available to the recipient and the spouse based on the second data; and
a display operatively coupled to the processor, configured to:
graphically display the calculated monthly benefits available to the recipient and the spouse based on the first data;
provide a graphical interface to receive the second data; and
dynamically alter the provided graphical display to display the monthly benefit available to the recipient and the spouse based on the second data.

11. The system of claim 10 wherein the display is further configured to simultaneously display monthly Social Security benefits available to the recipient and the spouse based on the first data and the second data.

12. The system of claim 11 wherein the processor is further configured to calculate a cumulative Social Security benefit for the recipient and the spouse for the first and second data and a breakeven point, and
wherein the display is further configured to simultaneously display a graphical display of the calculated cumulative Social Security benefits including identifying the breakeven point.

13. The system of claim 12 wherein the processor is further configured to calculate a monthly benefit for surviving spouse for the first and second data for a plurality of ages of death for a non-surviving spouse, and
wherein the display is configured to simultaneously display a graphical display of the calculated monthly benefit for surviving spouse.

14. The system of claim 10 wherein the graphical interface includes a slider bar to input the second data.
